(19) United States
(12) Patent Application Publication
(10) Pub. No.: US 2016/0105137 A1
(43) Pub. Date: Apr. 14, 2016

(54) CONTROL DEVICE FOR AN ASYNCHRONOUS MACHINE AND METHOD FOR OPERATING AN ASYNCHRONOUS MACHINE

(71) Applicant: ROBERT BOSCH GMBH, Stuttgart (DE)

(72) Inventors: Martin Braun, Neustetten-Wolfenhausen (DE); Simon Dietrich, Waiblingen (DE)

(21) Appl. No.: 14/889,658

(22) PCT Filed: Apr. 22, 2014
(86) PCT No.: PCT/EP2014/058073

§ 371 Date: Nov. 6, 2015

(30) Foreign Application Priority Data
May 10, 2013 (DE) 10 2013 208 591.5

(51) Int. Cl. H02P 23/14; G05B 17/02

(52) U.S. Cl. CPC H02P 23/14; G05B 17/02; H02P 2207/01

(57) ABSTRACT

The present invention provides a method and a device to determine the rotor field angle of an asynchronous machine even during the magnetising phase, in which the rotor field of a rotor of the asynchronous machine is built up. The asynchronous machine can then be actuated in a controlled operating mode even during the magnetising phase. The startup properties of the asynchronous machine can thus be improved, the magnetising phase of the asynchronous machine is shortened and it is possible to set a desired torque even during the magnetising phase.

### BACKGROUND OF THE INVENTION

The present invention relates to a control device for an asynchronous machine and a method for operating an asynchronous machine in a magnetization phase.

In order to be able to set a required torque precisely in an asynchronous machine, it is necessary, given field-oriented control of the asynchronous machine, to know the rotor field angle precisely. The determination of a rotor field angle in an asynchronous machine can be carried out here either by means of additional angle sensors or by means of an encoder-free method. When an additional angle encoder is used to determine the rotor field angle, additional sensors have to be attached to the rotation axis of the asynchronous machine, which sensors output a signal, which can be evaluated, as a function of the angle position of the rotor axis. In an alternative, encoder-free determination of the rotor field angle, the rotor position is determined by evaluating phase currents and voltages of the asynchronous machine. In this context, a differentiation is made between methods which permit reliable determination of the rotor field angle at high rotational speeds and methods which can be used at low rotational speeds and in a stationary state.

Document DE 10 2005 007 995 A1 discloses a method for determining the position of a rotor of an electric machine. In this context, a voltage is alternately applied to the stator phases, and an assignment of the stator phase to a magnetic axis is determined on the basis of the currents which result here.

Since in the case of asynchronous machines, in contrast to permanently excited synchronous machines, there is no rotor field in the non-energized state, this rotor field has to be firstly built up before the inductivity is measured. Subsequently, the position of the rotor field can then be determined by measuring the inductivity. During this magnetization phase in which the rotor field is built up, an asynchronous machine is therefore firstly operated in a purely open-loop controlled fashion until the rotor field is completely built up. In this open-loop controlled operating mode, field-oriented closed-loop control of the asynchronous machine is not possible.

There is therefore a need for a control device for an asynchronous machine and a method for operating an asynchronous machine which already permits a closed-loop controlled operating mode of the asynchronous machine in a magnetization phase.

### SUMMARY OF THE INVENTION

The present invention provides, according to a first aspect, a control device for an asynchronous machine having a rotor field angle detector which is configured to determine a rotor field angle in a magnetization phase of the asynchronous machine; and a motor controller which is configured to actuate the asynchronous machine on the basis of the determined rotor field angle in the magnetization phase.

According to a further aspect, the present invention provides a method for operating an asynchronous machine in a magnetization phase, comprising the steps of making available the asynchronous machine in a magnetization phase; of determining a rotor field angle of the asynchronous machine; and of actuating the asynchronous machine in the magnetization phase on the basis of the determined rotor field angle.

One idea of the present invention is already to determine the rotor field angle of the asynchronous machine during a magnetization phase of an asynchronous machine and already to actuate the asynchronous machine on the basis of this rotor field angle in the magnetization phase in a closed-loop controlled operating mode.

As a result of the early determination of the correct rotor field angle during the buildup of the rotor field, the asynchronous machine can already be actuated early in a closed-loop controlled operating mode during the magnetization phase. It is therefore also already possible to set a predefined torque precisely during the magnetization phase.

A further advantage is that by virtue of the early closed-loop controlled operation of the asynchronous machine, the asynchronous machine can be magnetized significantly more quickly.

An additional advantage is that the asynchronous machine can already be operated with a predefined torque during the magnetization phase. This prevents an undesired torque occurring owing to an unknown rotor field angle. This increases the functional reliability of the asynchronous machine

In one embodiment of the control device according to the invention, the rotor field angle detector determines the rotor field angle in an encoder-free method. Therefore, no additional sensors whatsoever are required on the rotor axis in order to determine the rotor field angle already during the magnetization phase and to actuate the asynchronous machine in a closed-loop controlled operating mode.

In a further embodiment of the control device according to the invention, the rotor field angle detector also comprises a device for generating voltage pulses, wherein the device is configured to apply voltage pulses to stator phases of the asynchronous machine; a current-measuring device which is configured to measure a current response to the applied current pulses in the stator phases; and a device for determining a rotor field angle which is configured to determine the rotor field angle on the basis of the measured current responses. By applying voltage pulses to the asynchronous machine and by means of a subsequent evaluation of the current responses in the stator phases it is possible to determine the current rotor field angle precisely in encoder-free fashion without additional sensors.

According to a further embodiment, the motor controller of the control device according to the invention sets a predefined torque in the asynchronous machine. Therefore, the asynchronous machine can already be operated with a defined torque during the magnetization phase.

In a further embodiment, the magnetization phase of the asynchronous machine occurs during starting up of the asynchronous machine from the stationary state or acceleration of the asynchronous machine after an interruption in operation. Particularly in these operating states, a significant improvement in the operating behavior can be achieved by the inventive operation of the asynchronous machine.

The present invention also comprises an asynchronous machine having a control device according to the invention.

In a further embodiment of the method for operating an asynchronous machine, in the step for determining the rotor field angle of the asynchronous machine the rotor field angle is determined by means of an encoder-free method. Therefore, no additional external sensors for determining the rotor field angle are necessary.

In a specific embodiment, the step for determining the rotor field angle comprises the steps of applying voltage pulses to the asynchronous machine; measuring a current response to the applied current pulses in the stator phases; and determining the rotor field angle on the basis of the measured current responses. As a result, precise, encoder-free determination of the current rotor field angle can take place.

### BRIEF DESCRIPTION OF THE DRAWINGS

Further features and advantages of embodiments of the invention can be found in the following description with reference to the appended drawings, in which:

FIG. 1 shows a schematic illustration of a control device for an asynchronous machine according to one embodiment of the present invention;

FIG. 2 shows a diagram with a schematic illustration of the time profile of the magnetization current and the phase current in an asynchronous machine during the magnetization phase according to a further embodiment of the invention;

FIG. 3 shows a schematic illustration of a method for operating an asynchronous machine according to a further embodiment of the present invention; and

FIG. 4 shows a diagram with a schematic illustration of the time profile of the magnetization current and the phase current in an asynchronous machine during a magnetization phase.

### DETAILED DESCRIPTION

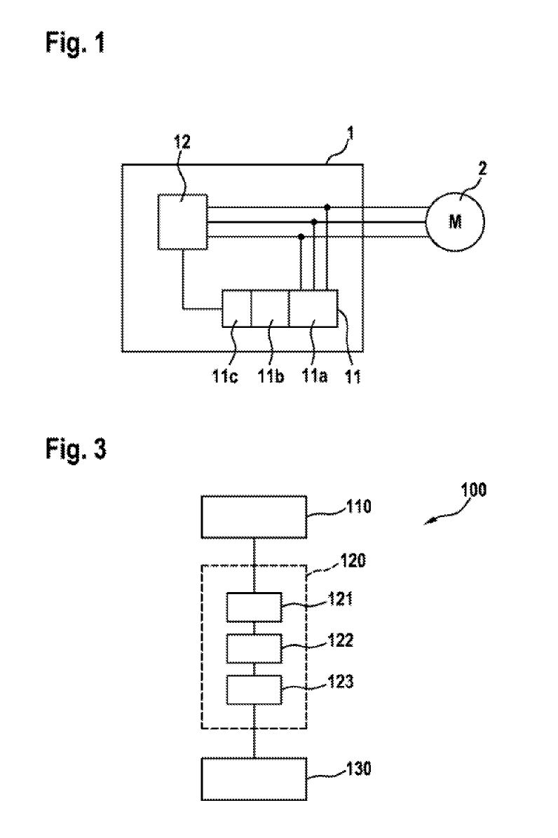

FIG. 1 shows a schematic illustration of a control device 1 for an asynchronous machine 2 as forms the basis of an embodiment of the present invention. The asynchronous machine 2 can be here any asynchronous machine, in particular an asynchronous motor with short-circuit rotor. The asynchronous machine is preferably a three-phase asynchronous machine. Such an asynchronous machine comprises a rotatably mounted rotor in the interior and an exterior fixed stator. A plurality of stator phases which are offset equidistantly from one another are let into the stator here. These stator phases are embodied, for example, as wire windings.

Since the rotor voltage is induced by means of the stator magnetic field in asynchronous machines, there is firstly no rotor field in the non-energized state in asynchronous machines. This rotor field firstly has to be built up during a magnetization phase. Conventional determination of the rotor field angle by measuring the inductivity is therefore not initially possible.

The determination of the rotor field angle is therefore carried out by means of a rotor field angle detector 11. This rotor field angle detector 11 applies, in brief succession, voltage pulses to the stator phases of the asynchronous machine. At the same time, the rotor field angle detector 11 measures the current responses in all the phases of the stator phases. Such measurement of the current responses can be carried out, for example, by determining a voltage drop across a shunt resistor. However, other methods for determining the current responses in the stator phases are also possible. Since the inductivities of the phases change as a function of the field angle owing to saturation, the rotor field angle detector 11 can thus determine the precise position of the rotor field angle. For this purpose, the rotor field angle detector 11 makes use of the saturation properties of the asynchronous machine, which are conditioned, inter alia, by the rotor field.

For example, the device 11a for generating voltage pulses applies, for this purpose, two voltage pulses with different signs in brief succession. For example, firstly a positive and subsequently a negative voltage pulse can be applied in any desired direction in brief succession. Subsequently, the resulting current responses in the stator phases of the asynchronous machine 2 are measured by means of the current-measuring device 11b. The device 11c for determining a rotor angle subsequently evaluates the current responses and determines the current rotor field angle therefrom and transmits this rotor field angle to the motor controller 12.

The current rotor field angle of the asynchronous machine 2 is determined by the rotor field angle detector 11 already in the magnetization phase of the asynchronous machine here, that is to say even before the rotor field has completely built up in the asynchronous machine 2. This is the case, for example, if the asynchronous machine 2 is starting up, that is to say, for example, is accelerated from the stationary state.

Furthermore, operating states are also possible in which the actuation of the asynchronous machine 2 has been interrupted for a specific time, with the result that the rotational speed of the asynchronous machine 2 is reduced during this interruption. After such an interruption, the asynchronous machine 2 is then to be subsequently accelerated again once more to the rated rotational speed. If the rotational speed of the asynchronous machine 2 has reduced in the process, without, however, the asynchronous machine 2 having completely come to a standstill here, the current rotor field angle cannot be determined in an encoder-free fashion in a conventional way, since the rotor field could not be maintained during this interruption either. Therefore, with conventional systems it is necessary firstly to bring the asynchronous machine 2 completely to a standstill and subsequently to accelerate the asynchronous machine 2 in an open-loop controlled operating mode and in the process build up the rotor field again.

In order to avoid this braking and renewed acceleration, in such an operating case the rotor field angle detector 11 can also determine the rotor field angle of the asynchronous machine 2 by means of the method described above, immediately after the interruption has been terminated. Subsequently, even in the event of the rotational speed having been reduced during the interruption, actuation can continue to be carried out by the motor controller 12 in the closed-loop controlled operating mode 3 immediately after the termination of the interruption, without the asynchronous machine 2 having had to be previously completely braked.

The correct rotor field angle can therefore always already be determined even in this magnetization phase by a measurement of the inductivity by the rotor field angle detector 11. Therefore, the asynchronous machine can already be actuated in a closed-loop controlled operating mode in the magnetization phase even before the rotor field has completely built up. The asynchronous machine can therefore already be operated in the closed-loop controlled operating mode even during starting up or revving up and also immediately after an interruption in operation. Interruptions in the operation of an asynchronous machine can occur, for example, if, owing to disruption of any kind, the energy supply has to be briefly interrupted. In this context, the rotation speed of the asynchronous machine decreases gradually. If the energy supply returns again after such an interruption before the asynchronous machine has completely come to a standstill, the asynchronous machine can again be operated further in the closed-loop controlled operating mode by virtue of the determination of the correct rated field angle, and the rated rotational speed and the desired torque can therefore be reached again particularly quickly. In contrast, without knowledge of the correct rotor field angle, the asynchronous machine would firstly have to be brought to a standstill and subsequently the rotor field would have to be built up again according to the prescriptions in an open-loop controlled operating mode, before a closed-loop controlled operating mode is possible on the basis of the rotor field angle.

Furthermore, the rotor field angle detector 11 can also transfer the determined rotor field angle to further processing units. For example, the position of the rotor, which is determined by the rotor field angle detector 11, can be transferred to a safety device (not illustrated) which monitors the operation of the asynchronous machine and, if appropriate, detects unacceptable operating states or disruptions. Monitoring of the asynchronous machine is therefore also possible without additional sensors for the rotor position, even if the asynchronous machine is still in the magnetization phase. In this way, it is therefore possible to ensure, in particular, a safe operating mode of the asynchronous machine without additional sensors having to be mounted on the asynchronous machine 2 in order to monitor the rotor position.

In addition, the rotor position which is determined by the rotor field angle detector 11 can also be compared with the angular position of an additional sensor for determining the rotor position. Given deviations between the two results, it is possible to infer that there is a fault. Additional safety is thus already achieved during the starting up and the magnetization phase of the asynchronous machine.

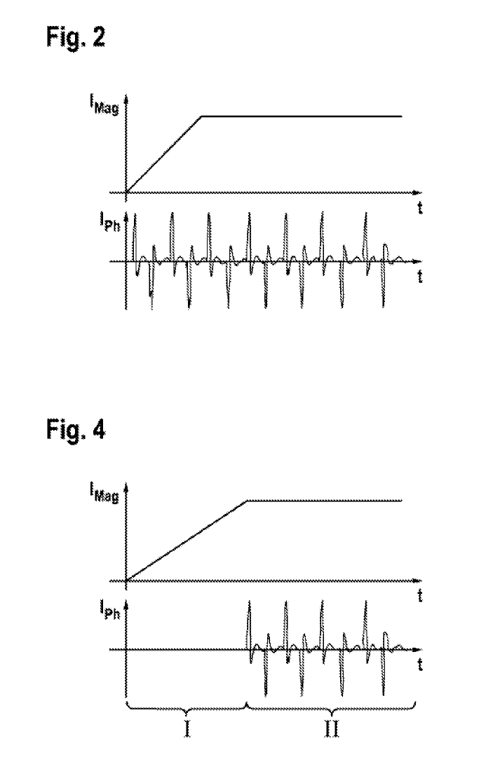

FIG. 2 shows a schematic illustration of the magnetization current I_{Mag} in the rotor and the phase current I_{Ph} of an asynchronous motor such as occur during the starting up of an asynchronous machine according to an embodiment of the present invention. In the upper diagram, the magnetization current I_{Mag} in the rotor is illustrated in this context. This magnetization current I_{Mag} initially increases approximately linearly until the rotor field is completely built up. When the rotor field is built up, the magnetization current I_{Mag} subsequently remains constant. In the lower part, the profile of the phase current I_{Ph} is illustrated schematically within a stator phase. Owing to the closed-loop control which already starts very early, in this context the asynchronous machine can already be actuated in the closed-loop controlled operating mode at a very early time, which is apparent by means of a phase current I_{Ph} with corresponding peaks in the current profile of the phase current I_{Ph}.

FIG. 4 shows, for the purposes of comparison, a schematic illustration of the magnetization current I_{Mag} and phase current I_{Ph} in a conventional method. It is apparent here that firstly during a time period I the asynchronous motor is operated in an open-loop controlled operating mode with permanently predefined parameters. Only after the rotor field has built up completely and a constant magnetization current I_{Mag} is flowing in the rotor can the rotor field angle be determined in a conventional way and therefore the open-loop controlled operating mode II be adopted.

As is apparent here from a comparison of FIGS. 2 and 4, by virtue of the inventive operation of the asynchronous machine the period of time until the magnetization phase is terminated and a constant magnetization current I_{Mag} has been set in the rotor can be significantly shortened. The asynchronous machine can therefore be operated significantly earlier at the optimum operating point. This is made possible by the knowledge of the rotor field angle during the magnetization phase, which permits precise closed-loop control of the phase currents instead of a purely open-loop controlled operating mode during this time.

FIG. 3 shows a schematic illustration of a method 100 for operating an asynchronous machine 2 in a magnetization phase according to a further embodiment of the invention. Firstly, in step 110, an asynchronous machine 2 is made available which is in an operating state in which the rotor field is built up (magnetization phase). Subsequently a rotor field angle of the asynchronous machine 2 is already determined in this magnetization phase in step 120. This determination of the rotor field angle is preferably carried out here by means of an encoder-free method. The disadvantages of additional rotary angle encoders, such as, for example, the additional expenditure on hardware and spatial requirement, as well as the associated relatively high costs, can therefore be avoided. In order to determine the rotor field angle in step 120, voltage pulses are applied to stator phases of the asynchronous machine 2 here in step 121. In particular, at least two voltage pulses with different signs are applied in brief succession to the stator phases of the asynchronous machine 2 here. For example, a positive voltage pulse and subsequently a negative voltage pulse can initially be applied to the asynchronous machine 2. In step 122, the current responses to the applied current pulses in the stator phases are subsequently measured. The determination of the current responses can be carried out here either by measuring a voltage drop across a shunt resistor or by any other method. Finally, in step 123 the rotor field angle is determined on the basis of the previously measured current responses. The determination of the rotor field angle is based here on a dependence of the inductivity of the phases on the rotor field angle owing to saturation.

After the rotor field angle has previously been determined in a preferably encoder-free fashion by applying voltage pulses to the asynchronous machine 2 and evaluating the voltage responses, in step 130 the asynchronous machine can subsequently already be actuated in the magnetization phase of the asynchronous machine 2 on the basis of this rotor field angle in an open-loop controlled operating mode.

To summarize, the present invention relates to a method and a device for already determining a rotor field angle of the asynchronous machine during the magnetization phase in which the rotor field of a rotor of an asynchronous machine is built up. Subsequently, the asynchronous machine can already be actuated during the magnetization phase in a closed-loop controlled operating mode. Therefore, the starting up properties of the asynchronous machine can be improved, the magnetization phase of the asynchronous machine can be shortened and the setting of a desired torque is already possible in the magnetization phase.

1. A control device (1) for an asynchronous machine (2) having:
a rotor field angle detector (11) which is configured to determine a rotor field angle in a magnetization phase of the asynchronous machine (2); and
a motor controller (12) which is configured to actuate the asynchronous machine (2) on the basis of the determined rotor field angle in the magnetization phase.

2. The control device (1) as claimed in claim 1, wherein the rotor field angle detector (11) determines the rotor field angle in an encoder-free method.

3. The control device (1) as claimed in claim 1, wherein the rotor field angle detector (11) also comprises:
a device for generating voltage pulses (11a) which is configured to apply voltage pulses to stator phases of the asynchronous machine (2);
a current-measuring device (11b) which is configured to measure a current response to the applied current pulses in the stator phases; and
a device (11c) for determining a rotor field angle which is configured to determine the rotor field angle on the basis of the measured current responses.

4. The control device (1) as claimed in claim 1, wherein the motor controller (12) sets a predefined torque in the asynchronous machine (2).

5. The control device (1) as claimed in claim 1, wherein the magnetization phase of the asynchronous machine (2) occurs during starting up of the asynchronous machine (2) from the stationary state.

6. An asynchronous machine (2) having a control device as claimed in claim 1.

7. A method (100) for operating an asynchronous machine (2) in a magnetization phase, comprising the steps:
making available (110) the asynchronous machine (2) in a magnetization phase;
determining (120), by a rotor field angle detector, a rotor field angle of the asynchronous machine (2); and
actuating (130), by a controller, the asynchronous machine (2) in the magnetization phase on the basis of the determined rotor field angle.

8. The method as claimed in claim 7, wherein the rotor field angle is determined by an encoder-free method.

9. The method as claimed in claim 8, wherein the step (120) for determining the rotor field angle comprises the following steps:
applying (121) voltage pulses to the asynchronous machine (2);
measuring (122) a current response to the applied current pulses in the stator phases; and
determining (123) the rotor field angle on the basis of the measured current responses.

10. The control device (1) as claimed in claim 1, wherein the magnetization phase of the asynchronous machine (2) occurs during acceleration of the asynchronous machine (2) after an interruption in operation.
